(19) United States
(12) Patent Application Publication
(10) Pub. No.: US 2007/0269070 A1
(43) Pub. Date: Nov. 22, 2007

(54) Hearing device with screwed closing arrangement

(75) Inventors: Robert Kasanmascheff, Hochstadt (DE); Harald Klemenz, Furth (DE); Frank Koch, Erlangen (DE); Tom Weidner, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AUDIOLOGISCHE TECHNIK GMBH

(21) Appl. No.: 11/804,144

(22) Filed: May 17, 2007

(30) Foreign Application Priority Data
May 19, 2006 (DE) 10 2006 023 722.6

(51) Int. Cl. H04R 25/00

(52) U.S. Cl. 381/324; 381/322

(57) ABSTRACT

There is described a hearing device. A module is enabled to be easily attached to the casing of a hearing device, in particular a hearing aid. Toward that end a bridge is provided which has a drilled hole. A screw is inserted through a drilled hole in the module and screwed into the drilled hole of the bridge so that the module or, as the case may be, the closure of the opening is compressed onto the opening by means of the screw. Alternatively a cylindrical projection into which the screw is screwed can also be molded onto the inner wall of the casing.

### CROSS REFERENCE TO RELATED APPLICATIONS

This application claims priority of German application No. 10 2006 023 722.6 DE filed May 19, 2006, which is incorporated by reference herein in its entirety.

### FIELD OF INVENTION

The present invention relates to a hearing device having a casing which has an opening, and to a closing arrangement by means of which the opening is closed externally in a detachable manner and which has a first drilled hole. The present invention relates in particular to a hearing aid, e.g. an in-the-ear hearing aid.

### BACKGROUND OF INVENTION

In order to be able to produce in-the-ear hearing aids more easily and cost-effectively, various manufacturers have made the transition to modularization. With this approach ready-made modules are introduced into a matching recess in the shell. On account of manufacturing tolerances it is necessary to use more or less complicated systems for anchoring the module in the shell. In some cases, therefore, the modules are glued into the hearing aid shell. However, special locking systems are also employed for anchoring the module.

The publication JP 11-055797 A discloses a hearing aid shell for an in-the-ear hearing aid which has an opening with an inward-projecting flange part. Drilled holes are provided in the flange part. A face plate can be screwed onto the flange part.

The publication US 2003 123 687 A1 also discloses a modular hearing aid having two faceplates which can be coupled together. The hearing aid shell has an opening with a shell edge portion. A part of the shell is clamped between the faceplate pieces when these are joined together. In this way the faceplates are secured to the hearing aid shell.

A hearing aid with a shell is known from the publication EP 1 315 401 B1. This hearing aid has a first, upper faceplate piece and a second, lower faceplate piece. The two pieces are screwed together by means of one or more screws and at the same time capture an edge or end portion of the hearing aid shell. The upper faceplate piece serves as a locking assembly for an opening in the shell and it is compressed against the opening by means of the screws, because the lower faceplate piece transfers the corresponding counterforce to the edge of the inner wall of the shell.

The publication DE 35 05 099 C2 also describes a hearing aid with a housing part which has an opening and four roughly cylindrical projections which are molded on the inner wall of the housing. A front plate is held in place in blind holes with the aid of pins. Screws can also be used instead of the pins.

### SUMMARY OF INVENTION

An object of the present invention is to simplify the attachment of a faceplate or a module to the hearing aid shell and at the same time to facilitate or, as the case may be, improve the assembly or the design of the hearing device.

Provided according to the invention for this purpose is a hearing device having a casing which has an opening, a closing arrangement by means of which the opening is closed externally in a detachable manner and which has a first drilled hole, and a screw which is inserted through the drilled hole and screwed into a second drilled hole so that the closing arrangement is compressed onto the opening by means of the screw, the casing having a stalagmite-like projection which is molded onto the inner wall of the casing and has the second drilled hole along its longitudinal axis, with the result that the screw is secured to the inner wall of the casing by means of the projection.

By means of the design according to the invention a simple assembly of the hearing device is achieved without the use of complex mechanical modules. Conversely, the hearing device can also be easily disassembled thanks to the advantageous design.

At least one further cylindrical projection and at least one further screw in each case with the cited function can be provided. By this means the closing arrangement can also be more effectively secured to the casing.

The closing arrangement can be part of a faceplate or, as the case may be, of an electronic module. The fastening according to the invention thus permits a module to be attached to the hearing aid casing in a simple manner.

The screw used for the fastening can have a self-tapping thread. In this way it is no longer absolutely essential for the second drilled hole to have an internal thread.

The hearing device can furthermore be embodied such that it has a replaceable seal between the closing arrangement and the opening. This enables a waterproof or dirt-proof closing of the opening to be achieved.

### BRIEF DESCRIPTION OF THE DRAWINGS

The present invention will now be explained in more detail with reference to the accompanying drawings, in which:

FIG. 1 shows a cross-section through a non-claimed hearing device and

FIG. 2 shows a cross-section through an embodiment of the present invention.

### DETAILED DESCRIPTION OF INVENTION

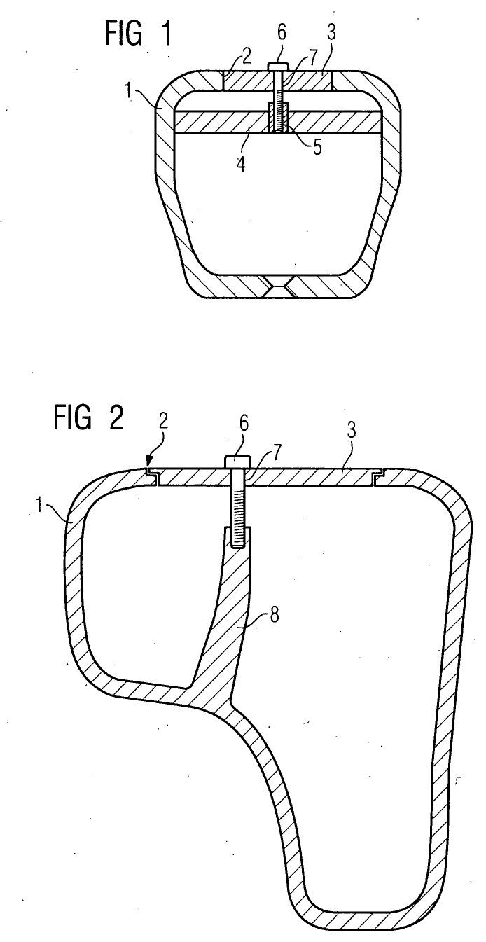

The exemplary embodiments described in more detail in the following represent preferred embodiments of the present invention. In connection with FIG. 1 constructional details of a hearing device are described first which can also be advantageous for the design according to FIG. 2.

The hearing aid shell 1 depicted in FIG. 1 possesses an opening 2. A faceplate 3 is inserted into this opening 2. For the sake of simplicity it is represented in FIG. 1 simply as a plate with a vertical edge. Similarly, the opening 2 is represented merely with a simple edge. In actual fact the opening 2 and/or the faceplate 3 possess(es) a contour at their/its edge, so that the faceplate 3 can be inserted into the opening 2 with a positive fit, without falling into the interior of the hearing aid shell 1.

Disposed in the interior of the hearing aid shell 1 is a bridge 4 which has a drilled hole 5 as a screw receptacle. Into this screw receptacle 5 is screwed a screw 6 which is inserted through a drilled hole 7 in the faceplate 3. Since the bridge is anchored in the interior of the hearing aid shell 1, the faceplate 3 is firmly anchored in the opening 2 of the hearing aid shell 1 by means of the screw 6.

The bridge 4 can be inserted subsequently into the hearing aid shell 1 as a separate part. In terms of its dimensioning it is necessary for it to be longer or, as the case may be, larger than an opening width of the opening 2. If the bridge 4 is then arranged parallel to the opening 2, it cannot be removed from the interior of the casing shell 1 through said opening 2.

Alternatively the bridge 4 is joined to the hearing aid shell 1 as a single piece. In this way the bridge 4 including the drilled hole 5 can be molded into the shell during the production of the shell using, for example, “rapid prototyping” methods. The drilled hole 5 of the bridge 4 can be arranged vertically beneath the opening 2. It can, however, also be arranged outside of an imaginary cylinder whose longitudinal axis runs perpendicularly to the opening 2 and whose cylindrical surface area possesses the contour of the opening 2 in the circumferential direction. In this case the faceplate 3 can be secured by means of a transversely running screw 6 in the drilled hole 5.

The bridge 4 can be embodied in a rod shape or else in a star shape with the drilled hole 5 in the center. In any case it is ensured that the faceplate 3 or, as the case may be, the corresponding module is drawn sufficiently into the opening 2 by means of the screw 6.

The screw 6 possesses a self-tapping thread and therefore cuts its thread itself into the drilled hole 5 of the bridge 4. If countersunk head or spherical head screws or correspondingly shaped receptacles are used in the faceplate 3 it can be ensured that the screwing operation is also possible without difficulty even if the components become somewhat canted during assembly due to manufacturing tolerances.

FIG. 2 shows an embodiment of a hearing device according to the invention, wherein for the sake of clarity the electronic components in the interior of the shell 1 are not shown here either. Once again a faceplate 3 or, as the case may be, a module is to be screwed into the opening 2 of the hearing aid shell 1. In this case the opening 2 possesses a step-shaped contour in cross-section and the faceplate 3 has a contour corresponding thereto. Optionally a seal, for example a gasket, is introduced into the opening 2.

Internally, the hearing aid shell 1 possesses a cylindrical or rod-shaped projection 8 that is molded on as a single piece. Said projection may also, as indicated in FIG. 2, be embodied as slightly conical in shape and internally has a drilled hole into which the screw 6 can be screwed. The stalagmite-like projection 8 has the advantage that it requires very little installation space, which is important in particular for in-the-ear-hearing aids. Furthermore it can be placed at practically any position opposite the opening 2.

It goes without saying that rapid prototyping methods can also be used here for the production of the shell 1. Moreover the screws described in the foregoing can also be used with this embodiment.

Owing to the screwing arrangement the preferred embodiments described above permit easy assembly and equally easy disassembly without the use of complex mechanical modules. The screwing arrangement also eliminates waiting times that would be necessary if the module or, as the case may be, the faceplate were to be secured by means of an adhesive.

1.-5. (canceled)

6. A hearing device, comprising:
a casing;
an opening in the casing;
a closing device with a first hole, wherein the closing device is detachable and closes the opening externally;
a screw inserted through the first hole and screwed into a second hole to compress the closing device onto or in the opening via the screw; and
a projection integrally formed with an inner wall of the casing, wherein the projection has the second hole in a longitudinal axis of the projection, and wherein the screw is secured to the inner wall of the casing via the projection.

7. The hearing device as claimed in claim 6, wherein the first hole is drilled.

8. The hearing device as claimed in claim 6, wherein the second hole is drilled.

9. The hearing device as claimed in claim 6, wherein the projection is stalagmite-like.

10. The hearing device as claimed in claim 6, wherein the projection is cylindrical.

11. The hearing device as claimed in claim 6, wherein the hearing device has a further projection and at least one further screw to work jointly with the further projection.

12. The hearing device as claimed in claim 6, wherein the closing device is a part of an electronic module.

13. The hearing device as claimed in claim 6, wherein the screw has a self-tapping thread.

14. The hearing device as claimed in claim 6, wherein a replaceable seal is between the closing device and the opening.

15. A in the ear hearing device, comprising:
a casing;
an opening in the casing;
a closing device with a first hole, wherein the closing device is detachable and closes the opening externally;
a screw inserted through the first hole and screwed into a second hole to compress the closing device onto the opening via the screw; and
a projection adjacent to an inner wall of the casing, wherein the projection has the second hole in a longitudinal axis of the projection, and wherein the screw is secured to the inner wall of the casing via the projection.

16. The in the ear hearing device as claimed in claim 15, wherein the projection is stalagmite-like.

17. The in the ear hearing device as claimed in claim 15, wherein the hearing device has a further projection and at least one further screw to work jointly with the further projection.

18. The in the ear hearing device as claimed in claim 15, wherein the closing device is a part of an electronic module.

19. The in the ear hearing device as claimed in claim 15, wherein the screw has a self-tapping thread.

20. The in the ear hearing device as claimed in claim 15, wherein a seal is between the closing device and the opening.

21. The in the ear hearing device as claimed in claim 15, wherein the closing device is a faceplate.

22. The in the ear hearing device as claimed in claim 15, wherein the closing device has a contour at an edge of the closing device to prevent the closing device from falling into an interior of the in the ear hearing device.

23. The in the ear hearing device as claimed in claim 15, wherein the opening has a contour at an edge of the opening to prevent the closing device from falling into an interior of the in the ear hearing device.

24. The in the ear hearing device as claimed in claim 15, wherein the screw has a countersunk head.

25. The in the ear hearing device as claimed in claim 15, wherein the closing device is a part of an electronic module.
